(19) United States
(12) Patent Application Publication
(10) Pub. No.: US 2012/0166248 A1
(43) Pub. Date: Jun. 28, 2012

(54) REMOTE IDENTIFICATION AND VERIFICATION OF STORAGE SYSTEMS

(76) Inventor: Yoav SILBERSTEIN, Kadima (IL)

(21) Appl. No.: 13/324,665

(22) Filed: Dec. 13, 2011

Related U.S. Application Data
(60) Provisional application No. 61/427,482, filed on Dec. 28, 2010.

(51) Int. Cl. G06Q 10/06

(52) U.S. Cl. 705/7.28; 705/7.11

(57) ABSTRACT

A system and method for generating a contract related to a data recovery. Storage components may be automatically examined by a module that may be automatically downloaded from a server, over a computer network. Hardware information and an identification parameter may be obtained and sent to a server. A contract may be generated based on information received by the server. A contract may be validated and data recovery service may be provided based on a validated contract.

### CROSS REFERENCE TO RELATED APPLICATIONS

This application claims benefit of U.S. Provisional Patent Application Ser. No. 61/427,482 filed on Dec. 28, 2010 and entitled “Remote identification and verification of computerized and digital part” the entirety of which is incorporated herein by reference.

### BACKGROUND OF THE INVENTION

Risk may generally be described as a danger or probability of loss. Insurance is related to risk management, enabling hedging against a risk of a contingent loss by transferring, in exchange for payment, a risk of a loss from one entity to another. Generally, an insurer is an entity selling the insurance policy, and an insured (or policyholder), is the entity buying the insurance. In underwriting a risk-related contract, such as a service contract or an insurance policy, an insurer assumes a potential future liability in case of a specified loss. The insurance rate, called the premium, is a factor used to determine the amount to be charged for a certain amount of insurance coverage.

Determining or assessing a risk may be crucial to some or all parties to a risk-related contract and/or to drafting the contract, which details the conditions and/or circumstances under which an insured party is to be compensated or provided with a service by an insuring party. A method of assessing a risk (as well as possibly determining an insurance coverage and/or premium) may include determining a condition of and insured asset or entity. For example, life insurance premiums are typically calculated largely based on factors such as age, medical condition, and the like. Similarly, in drafting a home insurance policy, structural aspects the relevant house or building may be examined, and likewise, a process of producing a car service contract typically includes inspecting the car.

One of the most valuable assets related to computing devices is data stored on such devices. Data stored on computing devices may be corrupted, e.g., as a result of hardware failure, human error, or other circumstances. Accordingly, data recovery may sometimes be required. Accordingly, a service contract or insurance policy related to data recovery may be provided by a service provider or insurer.

However, when generating a contract for servicing or insuring computing devices and/or data recovery, a physical, on site inspection may be undesirable. For example, the insuring or service providing company may be remotely located. In other cases, e.g., when engaging in a service or insurance contract for a large organization, a large number of computers may need to be inspected which, in turn, may entail substantial time and cost. In addition, with respect to a contract related to a restoration of lost data stored on a computing device, a physical and/or functional inspection may not suffice in order to assess possible risks nor in order to obtain information that may be required in a data restoration process.

Furthermore, while an insured car or house may be easily and uniquely identified (e.g., when an insured entity claims compensation), uniquely or positively identifying components installed in a computing device may be a complicated task. For example, prior art methods may be directed to attaching a label or otherwise marking a component such as a computer disk drive thus uniquely identifying the component. Such methods may further dictate that an insurance or liability expires or is invalidated if the label or marking are removed or missing. In addition, current systems and methods do not enable preventing a user from generating false information (e.g., a false serial number identifying a disk) when engaging in, or activating a service or insurance contract.

### SUMMARY OF EMBODIMENTS OF THE INVENTION

According to some embodiments, in order to generate a data recovery contract, storage components may be automatically examined by a module that may be automatically downloaded from a server, over a computer network. Hardware information and at least one identification parameter may be obtained and sent to a server. A contract (e.g., a service or insurance contract or policy) may be generated based on information received by the server. A contract may be validated and data recovery service may be provided based on a validated contract.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 shows a block diagram of an exemplary setup according to embodiments of the invention; and

FIG. 2 is a flowchart describing a method of generating a contract according to embodiments of the invention.

It will be appreciated that for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently.

Embodiments of the system and method of the present invention may be used for automatically and/or remotely initiating an examination and/or identification of components installed in a computing device, and conducting such examination and/or identification. More specifically, inspection, examination and/or identification of storage components installed in a computing device may be performed in order to generate a contract related to servicing the computing device, servicing components installed in the computing device, and/or generating a contract related to restoring data stored on the computing device. Embodiments of the invention may enable automatically and/or remotely initiating operations related to inspecting, inventorying, and/or identifying components in a computing device. Embodiments of the invention may enable automatically examining, inventorying and/or identifying data stored in one or more storage devices or systems operatively connected to an inspected computing device.

Information obtained in an automatic inspection process may be used to generate a service or insurance contract. Information obtained and/or stored in an automatic inspection process may be used to uniquely identify a component. Identification information obtained during an automatic inspection process may be used, possibly prior to servicing a component, in order to identify the component, e.g., in order to ascertain a component for which service is requested is covered by an insurance, service or other contract. Information obtained in an automatic inspection may be used in order to restore data stored on a storage device, e.g., when such data is corrupted.

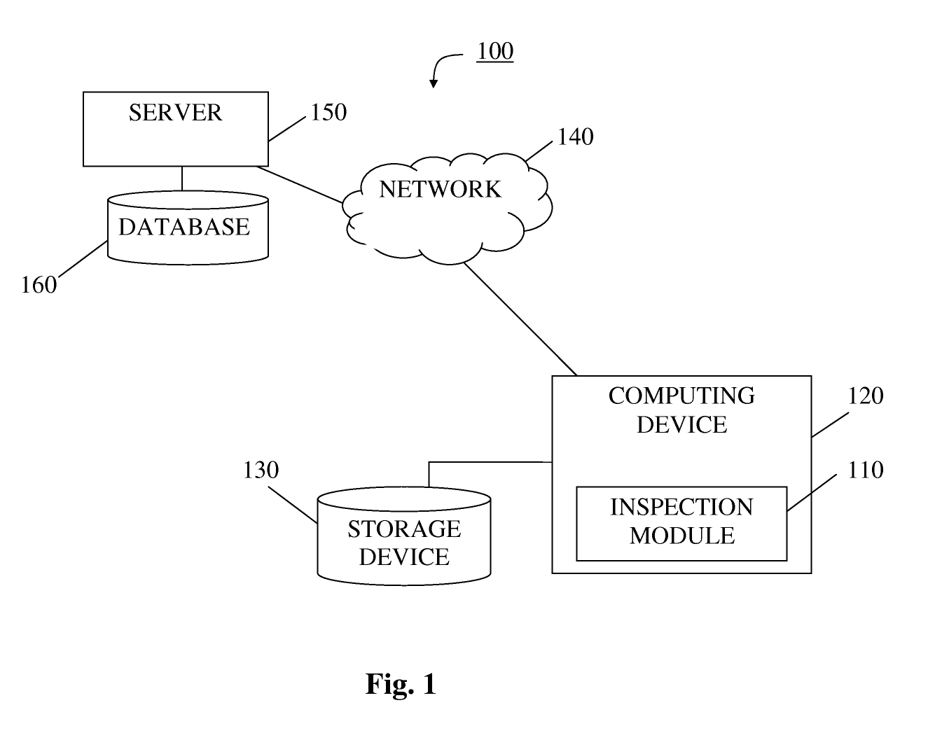

Reference is now made to FIG. 1, which shows a schematic block diagram of an exemplary setup 100, according to embodiments of the invention. Setup 100 may include a computing device 120, a network 140, a server 150, and a database 160, which may be operatively connected to server 150. As shown, an inspection module 110 may be installed in, or operatively associated with, computing device 120. As further shown, computing device 120 may be operatively connected to a storage device 130.

According to embodiments of the present invention, computing device 120 may be a client computing device, e.g., a computing device owned and operated by a private individual. For example, computing device 120 may be or may include a personal computer, a desktop computer, a laptop computer, a notebook computer, a terminal, a workstation, a server computer, a tablet computer, a network device, a household appliance or any other applicable computing device. Computing device 120 may not necessarily be a computer. For example, computing device 120 may be a telephone, a cellular phone, a smartphone or another communication device or it may be a Personal Digital Assistant (PDA) device, an MPEG-1 Audio Layer 3 (MP3) player, a camera, a Global Positioning System (GPS) device and the like.

Generally, any computing device capable of storing information may be applicable to embodiments of the invention. More specifically, any computing device including, or operatively connected to a non-volatile storage device or component may be applicable. For the sake of simplicity, a single computing device 120 (and associated inspection module 110) are shown, however, it will be understood that a large number of computing devices (and associated inspection modules) may exist in a typical setup according to embodiments of the invention.

Server 150 may be any server computer as known in the art, e.g., a web or application server. For example, server 150 may be or may include a personal computer, a desktop computer, a workstation, a server computer, a network device and/or any other suitable computing device. Storage 130 may be or may include, for example, a hard disk drive, a solid state drive (SSD), a floppy disk drive, a Compact Disk (CD) drive and/or media, a CD-Recordable (CD-R) drive and/or media, a camera card, a disk on key storage unit, a Redundant Array of Independent Disks (RAID) storage systems or any other suitable removable and/or fixed storage unit. In some embodiments, storage 130 may be or may include a flash memory component, a universal serial bus (USB) device or a tape drive and media.

Network 140 may be, may comprise or may be part of a private or public IP network, or the internet. Network 140 may also or in addition, be, comprise or be part of a global system for mobile communications (GSM) network. For example, network 140 may include or comprise an IP network such as the internet, a GSM related network and any equipment for bridging or otherwise connecting such networks as known in the art. In addition, network 140 may be, may comprise or be part of an integrated services digital network (ISDN), a public switched telephone network (PSTN), a public or private data network, a local area network (LAN), a metropolitan area network (MAN), a wide area network (WAN), a wireline or wireless network, a local, regional, or global communication network, any combination of the preceding and/or any other suitable communication means. It will be recognized that embodiments of the invention are not limited by the nature or type of network 140.

Storage device 130 may be any component capable of storing digital information. Storage device 130 may include, for example, a hard disk drive, a floppy disk drive, a Compact Disk (CD) drive, a CD-Recordable (CD-R) drive, or other suitable removable and/or fixed storage unit. Storage device 130 may include or may be a USB storage device, network storage device or a flash storage device. It will be recognized that the scope of the present invention is not limited or otherwise affected by the type, nature, operational and/or design aspects of storage device 130. For example, although for the sake simplicity and clarity, a single device is shown in FIG. 1, storage device 130 may comprise any suitable number of possibly different storage devices without departing from the scope of the present invention. Database 160 may be any storage system and associated application (e.g., a database management system (DBMS) application). Generally, database 160 may be any system configured to store, retrieve and organize large amounts of data. For example, database 160 may be a commercial database as known in the art.

Inspection module 110 may be or may comprise software, hardware, firmware or any combination thereof. For example, inspection module 110 may be a software application executing on computing device 120. Inspection module 110 may interact with server 150 and receive or send any information from/to server 150. For example, hardware information, device identifiers and/or other parameters collected and/or computed by inspection module 110 may be communicated to server 150 over network 140. Information received from inspection module 110, by server 150, may be stored in database 160 and may be used in generating an insurance policy, a service contract or another contract or agreement.

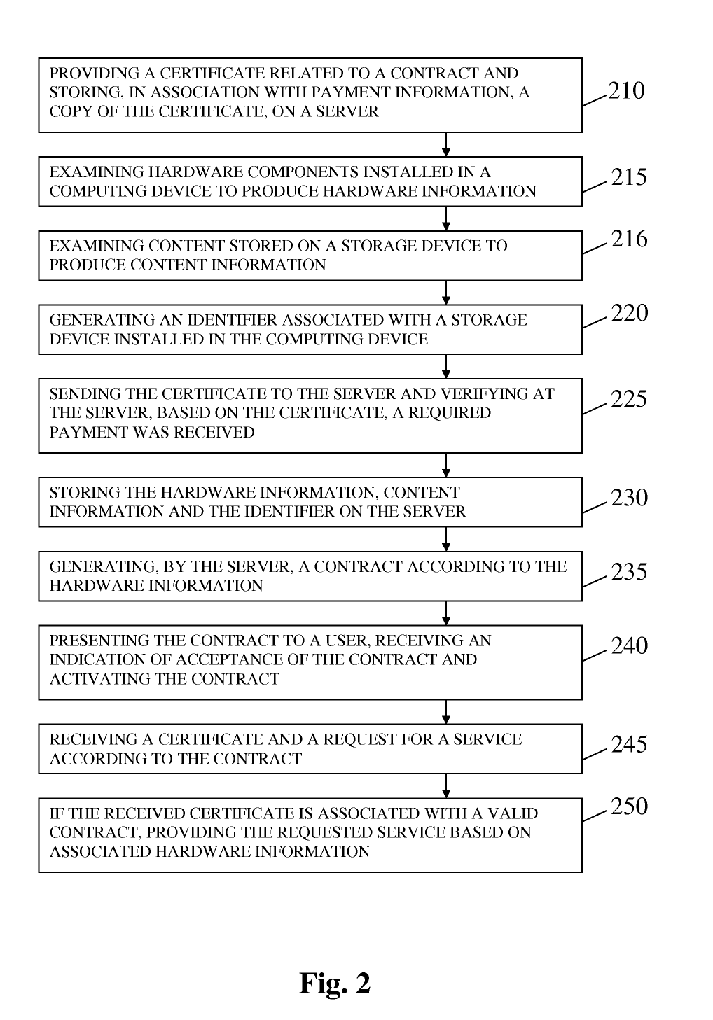

Reference is now made to FIG. 2 that shows a flowchart describing a method according to embodiments of the invention. As described herein, the method may enable online activating a contract related to servicing a computing device. For example, a prepaid service contract or insurance policy may be activated using embodiments of the invention. According to embodiments of the invention, a prepaid data recovery service may be activated by employing at least some of the operations described herein. As described herein, hardware information related to, and content stored on a storage device may be linked or associated with a an insurance policy. Hardware and content information may be automatically transferred from a computing device to a server and may be used to generate and/or activate a an insurance policy or a service contract.

Some of the method operations and/or elements shown in FIG. 2 and described herein may be optional. For example, operations such as examining content stored on a storage device, generating an identifier associated with a storage device, generating a contract according to hardware information, presenting a contract to a user and/or receiving an indication of acceptance of a contract may be omitted in some embodiments. For example, some embodiments may be related to an online activation of a prepaid contract, e.g., a prepaid data recovery service. In purchasing a prepaid data recovery service, a certificate may be provided in return for a payment and an online activation, e.g., as described herein, may activate the service. In such embodiments, generating a contract according to hardware information and/or presenting a contract to a user may be skipped.

In other embodiments, some of the operations or elements may be repeated or performed in a different order than the exemplary order shown and described herein. for example, in some embodiments, sending or providing a certificate to a server may precede operations such as examining hardware components installed in a computing device, examining content stored on a storage device, generating an identifier associated with a storage device. For example, an inspection module may not be downloaded to a computing device unless a valid certificate is first provided. Accordingly, it will be understood that embodiments of the invention are not limited by the order of operations or elements described herein, e.g., with respect to FIG. 2. In yet other embodiments, operations and/or elements described herein, e.g., with respect to the method or flow shown in FIG. 2 may be performed simultaneously, at the same point in time, or concurrently. For example, while a first module examines hardware components, another module may examine content, either on the same storage device or on another storage device that may be connected to the same computing device.

As shown by block 210, a method or flow may include providing a certificate related to a contract and storing, in association with payment information, a copy of the certificate, on a server. For example, a prepaid sale of a data recovery service may include providing by a service provider, in return for payment, a certificate that may be used in order to activate the prepaid service. Embodiments of the invention enable providing a prepaid data recovery service at the time of purchase of a computer and/or a storage device, e.g., a disk drive.

For example, a provider of data recovery services may issue a certificate to a retailer of storage equipment, to a manufacturer of storage systems, e.g., a manufacturer of hard disks or directly to users. Accordingly, embodiments of the invention enable a sale of a prepaid service by a data recovery service provider through a variety of channels, including but not limited to, selling a prepaid data recovery service to digital storage equipment manufacturers, computer manufacturers and retail distributors of computers. In other embodiments, a certificate may be sold directly to a user, e.g., over a network. Generally, a certificate may be provided to any entity and may later be used to activate a data recovery service, e.g., as described herein.

A copy of the certificate may be stored on a server, in a database or on any suitable system. For example, a copy of a certificate sold to a retailer may be stored on database 160. In some embodiments, a certificate may be a code or any parameter usable in order to verify a payment was made. In some embodiments, a certificate may include (e.g., encode) various parameters or information. For example, a date of issuance, a type of service and the like may all be encoded into a certificate. A certificate issued or sold by a service provider may be resold or transferred. For example, a retailer may purchase a certificate from a data recovery service provider and give the certificate to a customer upon a purchase of a computer.

In some embodiments, upon a purchase of a prepaid service the purchaser may be provided with a certificate or other authentication or verification code, e.g., a serial number associated with the purchased service. A certificate may be used, e.g., as described herein, to activate the prepaid service. Prior to an activation (e.g., an online activation), functional aspects of a component may be determined and/or verified. For example, a storage device may be examined.

As shown by block 215, a flow may include identifying and/or examining hardware components installed in a computing device to produce hardware information. An examination of hardware components may include verifying any aspects, factors or parameters related to examined hardware. For example, inspection module 110 may examine hardware components installed in computing device 120, e.g., inspection module 110 may examine storage device 130. An inspection module such as inspection module 110 may be installed and/or executed on a computing device such as computing device 120 according to any applicable method. In one embodiment, an inspection module may be preinstalled on a component. For example, a manufacturer of a storage device may, e.g., as part of a manufacturing process, store executable code on a storage device wherein the executable code, when executed by a computing device performs an inspection of the storage device. In another embodiment, inspection module 110 may be downloaded from a serve, e.g., from a web or other server on the internet. For example, a user may logon to a web site, provide required details (e.g., operating system type, storage device types, computing device type etc.) and may be provided with a downloadable module that may be downloaded to, and executed on a computing device. For example, a user operating computing device 120 may download inspection module 110 from server 150 over network 140.

In some embodiments, a service provider may enable an online activation of service. For example, using a computer, a client may log on to a service provider's website and select, in a web page, a tab identified as “Activation Online”. In response, an internet browser operated by the client may download and activate a special application that may be, for example, a Microsoft® ActiveX® application that may subsequently be installed on the client computer. For example, inspection module 110 may be such downloadable application. In some embodiments, an activation module may perform an inspection as described herein. For example, inspection module 110 may be or may include an activation module. In some cases, an activation and/or inspection may be preinstalled on a storage device, e.g., by a manufacturer of the storage device.

In yet another embodiment, e.g., in an organization, an inspection module may be automatically downloaded and executed on some or all computers or computing devices in an organization. For example, an administrator cause an automatic download of an inspection module to every computer connected to an organization's network (for example, a script executed upon boot or restart by computers in an organization may be modified to cause such download). The administrator may further cause an automatically downloaded inspection module to automatically execute and inspect a computing devices and/or perform other tasks, e.g., as described herein with reference to FIG. 2.

Hardware information produced based on an examination may include any data or parameters related to the inspected hardware. For example, storage capacity, read or write operations characteristics (e.g., speed, number of cycles required for an operation etc.), number of read/write heads, number of sectors may all be included in produced hardware information. Other information included in produces hardware information may be microcode identification parameters and/or other parameters such as disk manufacturer name or identification, disk model, disk serial number, various manufacturer's parameters stored on the disk drive, e.g., disk part number, printed circuit board (PCB) part number, firmware version, manufacturer codes etc. Examining hardware components may include obtaining information from any source, component or system. For example, examining hardware components may include obtaining information from a Self-Monitoring, Analysis, and Reporting Technology (S.M.A.R.T.) component, e.g., one installed in a computing device and/or in or on a specific storage device. As known in the art, S.M.A.R.T. is a monitoring system that may detect, record and report various aspects of storage devices. For example, a S.M.A.R.T. system may provide reliability indicators that may be usable in anticipating failures of a hard drive. Accordingly, embodiments of the invention may interact with a S.M.A.R.T. system to obtain any information relevant to a storage device. For example, inspection module 110 may interact with a S.M.A.R.T. system on computing device 120 to obtain hardware information related to storage device 130.

Examining hardware components may include any applicable operation. For example, inspection module 110 may perform read operations from specific, predetermined and/or randomly selected areas of a hard drive. For example, read operations may be performed based on a disk type or model. For example, based on a disk type or other parameters, inspection module 110 may determine the number of read/write heads included in the disk drive and perform read operations such that all read/write heads are activated and tested. Write operation may also be performed. For example, inspection module 110 may determine or identify regions in storage device 130 where no data is stored, e.g., by inspecting or reading such regions and determining no data is stored in these regions. For example, a predefined pattern may be written to a storage device by a manufacturer of the device, accordingly, by reading a predefined pattern from a region, inspection module 110 may determine a region is not used for storing user data. Examining hardware components may comprise assessing or determining a condition of a component. For example, writing a specific pattern (e.g., to regions not used for storing user data) and successfully reading the pattern may be performed in order to determine functional aspects of a disk drive. Other than simply verifying read/write operations, parameters such as speed, power consumption, heat dissipation and/or any other operational aspects may be evaluated or recorded or otherwise included in a hardware information produced as shown by block 215.

An examination may include detecting a fault related to a storage component, recording the fault in the hardware information and suggesting an action related to the fault. For example, if a read operation performed by inspection module 110 fails, inspection module 110 may record the failure, report to a user (e.g., by a popup) and may suggest an action or operation. For example, inspection module 110 may suggest a checkdisk utility be activated to check and repair a faulty component. If an examination is terminated upon discovering a fault, then following a repair of the fault, an examination may be resumed.

As shown by block 216, a flow may include examining content stored on a storage device to produce content information. For example, inspection module 110 may examine content stored on storage device 130 to determine various parameters. An arrangement of content on a storage component may be examined and/or recorded, e.g., in a hardware information file, memory location or other object. For example, information related to an arrangement of content stored on a storage component (e.g., storage device 130) may be included in hardware information collected by inspection module 110 and sent to server 150.

For example, information such as a location and/or size of a file allocation table (and backup tables), storage allocation information such as block allocation size and the like may all be recorded in an article of content information. Generally, examining content stored on a storage device may include collecting information that may be relevant to any operation related to storing data on the storage device. As described herein, content information may be used in a restoration of data. Content information produced or obtained as shown by block 216 may include any content or parameters. For example, microcode identification parameters and/or other content, e.g., firmware, or (S.M.A.R.T.) information. Other information collected and/or produced, either as hardware information as shown by block 215 or as content, e.g., as shown by block 216 may be, for example, component's temperature, number of hours a component has already been used, number of times a component has been turned on, read and write error indications or messages, thresholds exceeded etc. For example, such information may be recorded by a S.M.A.R.T. system, accordingly, inspection module 110 may obtain such information from a S.M.A.R.T. system.

As shown by block 220, a flow may include generating an identifier associated with a storage device installed in the computing device. For example, an identifier associated with storage device 130 may be generated (e.g., by inspection module 110) based on parameters extracted from storage device 130. For example, in a case where storage device 130 is a disk, parameters such as disk manufacturer name or identification, disk model, disk serial number, various manufacturer's parameters stored on the disk drive, e.g., disk part number, printed circuit board (PCB) part number, firmware version, manufacturer codes, manufacturer site code may all be used in generating an identifier.

Other information may be used in generating an identifier. For example, information related to a hosting computing device (e.g., a computing device to which a storage device is connected) may be used, for example, a computer's serial number, an attached network interface card (NIC) media access control (MAC) address or other parameters that may uniquely or otherwise identify a computing device, a storage device and/or a combination of a computing device and attached storage device may all be used. An identifier may be generated based on any parameter, e.g., as described herein and further based on any combination, method, process or algorithm. For example, input to a function or calculation may be a disk part number, a printed circuit board (PCB) part number, a firmware and a date and time parameter and an output of such function or calculation may be an identifier.

Although in some embodiments an identifier may be unique, in other embodiment such requirement may not be in place. For example, an identifier may serve in order to identify a disk (e.g., disk type, model etc.) and may not be unique. For example, an identifier may be used in order to determine the type of service that may be required and, accordingly, may need not be unique. For example, based on an identifier, embodiments of the invention may determine whether a storage device is a hard drive, a flash memory device, an internal storage component in a smartphone etc. Accordingly, an identifier may be generated based on an intended use.

Although for the sake of simplicity a single identifier is described as generated herein, any number of identifiers may be generated. For example, inspection module 110 may generate a first identifier that uniquely identifies storage device 130 and a second identifier that includes information such as disk type etc. For example, the first (unique) identifier may be used when a request for service is received, e.g., in order to verify or ascertain that a disk is indeed associated with a service contract or covered by a valid insurance policy and the second (possibly non-unique) identifier may be used when determining an insurance policy's parameters, quote, premium and the like. Although not specifically shown in FIG. 2, a failure to identify or examine hardware, obtain information or content or any other failure to perform an operation, e.g., any operation described herein as performed by inspection module 110 may result a termination of a service activation process, possibly accompanied by an indication to a user (e.g., using a popup window, an audible indication etc.).

As shown by block 225, a flow may include sending the certificate to the server and verifying at the server, based on the certificate, a required payment was received. For example, inspection module 110 may prompt a user operating computing device 120 to provide a certificate, e.g., a certificate provided to the user when purchasing storage device 130. Inspection module 110 may communicate the certificate to server 150. Copies (or parameters usable to identify) certificates issued by a service provider may be stored as described herein, e.g., on database 160. As described herein, various related parameters may be stored in association with stored certificates. For example, based on stored information in association with a certificate it may be possible to determine whether a full payment was made for a service associated with an issued certificate. In some embodiments, a certificate may be provided, e.g., to server 150, by the client. For example, in an embodiment enabling online activation as described herein, after logging onto a web site operated by a service provider, a user may provide a certificate or serial number (and possibly other information, e.g., contact information, address, email etc.)

Accordingly, upon receiving a certificate, server 150 may use the certificate to locate related information in database 160 and verify the certificate, e.g., verify the certificate is authentic, the certificate has not been claimed to be possessed by another user or entity etc. For example, server 150 may verify, based on a received certificate and information stored in database 160, that a required payment for a service associated with a received certificate was received.

As shown by block 230, a flow may include communicating the identifier and hardware information to the server and storing the storing the hardware information, content information and the identifier on the server on the server. For example, any information collected by inspection module 110 may be communicated to server 150, including hardware information, content information and one or more identifiers as described herein. Any information received from inspection module 110 may be stored, e.g., on database 160 such that it may be retrieved based on a relevant key or parameter. For example a database key used for storing data received from inspection module 110 may be a certificate. Accordingly, when a certificate is provided to server 150 (e.g., upon requesting a service), any information relevant to a device to be serviced or to a relevant service contract may be readily obtained.

In some embodiments, hardware information, an identifier or any other information collected and/or generated (e.g., by inspection module 110 with relation to storage device 130) may be encoded into a unique resource locator (URL). For example, a URL may generated by appending or suffixing encrypted hardware information and an identifier to a domain. A browser may use the URL to access a server, e.g., based on the domain. The server may analyze the URL and validate the hardware information and the identification. For example, the server may decrypt encrypted information in a URL and verify the information was produced by module 110, e.g., based on a predefined format. Accordingly, an automated method of collecting information from a computing device may be such that a user may be prevented from tampering with information sent to a server, e.g., alter a serial number of a disk. Rather than having a user provide information related to a storage component that is to be insured or for which a data recovery contract is to be generated, embodiments of the invention may automatically collect the information without any involvement of a user. Accordingly, examining hardware components, producing hardware information and obtaining the at least one parameter that may uniquely identify a storage component may be performed automatically by a module (e.g., inspection module 110) that may be automatically downloaded (e.g., from server 150), over a network (e.g., network 140), to the computing device (e.g., computing device 120).

As shown by block 235, a flow may include generating, by the server, a contract according to the hardware information. Based on information related to storage components and/or actual stored data, inspection module 110 or server 150 may assess a risk related to a loss of data. A service contract, insurance policy or other contract may be generated based on an estimated or assessed risk. For example, based on a type or age of a disk, type of data stored on a disk or other parameters, a premium may be determined and reflected in a generated contract. For example, based on hardware and/or content information, e.g., obtained as described herein, a risk or other aspects may be calculated, and a service contract or insurance policy may be generated based on a calculated risk.

An insurance policy may be automatically generated or modified based on information automatically obtained, e.g., by inspection module 110 as described herein. For example, a first disk type or model may be known to be more durable than a second disk type, e.g., a mean time between failures (MTBF) of a first disk may better than that of a second disk. By determining a disk type and model, e.g., in an inspection process described herein and further providing such information to server 150, server 150 may automatically generate an insurance policy or a data recovery service contract that takes a risk of failure such as loss of data into account. Accordingly, embodiments of the invention enable automatically collecting data related to a storage (or other computing) device, automatically calculating a risk based on collected information and automatically generating a service contract or insurance policy based on collected information.

In some embodiments, a policy may be fixed or predetermined. For example, terms of an insurance policy or service contract may be predetermined, e.g., before during or after a sale of a policy. For example a policy may generally cover for restoration of lost data on a storage device for a predefined time period and the policy may be fixed in the sense that it does not depend on parameters collected from the disk or at the associated computing device. In such embodiments, the operation of generating, by the server, a contract according to the hardware information may include recording various parameters of an insured storage device and modifying a policy based on risks or other aspects determined based on hardware and/or content may be bypassed or omitted from a flow.

As shown by block 240, a flow may include presenting the contract to a user, receiving an indication of acceptance of a term in the contract or of the contract and activating the contract. For example, in the case of automatically generating an insurance policy, e.g., as described herein, the automatically generated policy may be presented to a user, possibly enabling the user to accept, decline or suggest modifications to, the policy. In other embodiments, e.g., when the policy is fixed, e.g., at the time of purchasing the policy (or an associated certificate), the operation of presenting the policy or contract to a user may be skipped.

As shown by block 245, a flow may include receiving a certificate and a request for a service according to the contract. For example, in case of data loss, disk failure or other circumstances, a user or organization previously provided with a certificate may provide the certificate that may be used, e.g., in conjunction with parameters extracted from a storage device, to verify the holder of the certificate is indeed a holder of an insurance policy related to the storage device for which service is required. For example, server 150 may use a certificate to locate information related to a storage device. For example, any information previously stored in database 160 in association with a certificate, e.g., as described herein, may be located and retrieved using a certificate. Accordingly, provided with a certificate, server 150 may locate and provide information related to a device and/or a contract. For example, using information previously stored in association with a certificate, e.g., a disk type, model etc. it may be possible to verify that a disk brought to a lab is indeed covered by an insurance policy or other service contract.

According to embodiments of the invention, subsequent to an activation of a service contract or insurance policy, a client may wish to be provided with a data recovery or other service related to a storage component. In some embodiments, the client may log on to a service provider's website and select, in a web page, an appropriate option, e.g., by selecting a “Submit Recovery Request”. In other embodiments, information such as a certificate, client contact information and the like may be provided to the service provider using any suitable means, e.g., by talking to an agent on a telephone or by facsimile (fax). Other than providing a certificate, serial number or other authentication information that may be associated with a contract, a client or a component to be serviced, a client may provide other information, e.g., personal contact information (that may be used for verification). Other information provided by a client may be, for example details regarding the circumstances of a loss of data or a disk drive malfunction or any information that may assist a data recovery process or other service. For example, a loss of data may be due to a virus attack, liquids spilt on a computer, etc. Such information may assist in an actual data recovery process and accordingly may be requested from a client requesting a service. A client may further indicate which parts of lost data he or she wishes recovered.

As shown by block 250, a flow may include, if a received certificate is associated with a valid contract, and the contract is related to a provided device to be serviced (e.g., a disk drive for which a service for restoration of data was generated as described herein) providing the requested service based on associated hardware information. Typically, in order to be serviced, a component may shipped, e.g., to a service center or lab operated by the service provided. At a service center or location, the component may be examined. For example, information such as hardware and/or content information may be extracted from a disk and may be compared to hardware and/or content information that may have been previously stored, e.g., as described herein in association with a certificate, and may be retrieved, e.g., based on a certificate provided by a client when requesting a service. Accordingly, prior to providing a service, a service provider may be enabled to verify or ascertain that a device or component for which service is requested is covered by a valid service contract or a valid insurance policy.

In some embodiments, e.g., when a data recovery service is provided, the service provider may update the client regarding a progress of the data recovery. For example, using the certificate, a client may log on to a web site and be provided with status regarding a progress of a data recovery process, e.g., what portions of the data have been thus far recovered or a list of files that have been recovered. In some embodiments, recovered data may be provided online, e.g., over the internet. For example, in conjunction with a certificate (e.g., a certificate as described herein) to authenticate a client, recovered data may be downloaded from a web site to a client computer.

Upon completion of a data recovery process, a client may receive from a service provider a comprehensive list of the recovered files, data or content before the data is actually provided, for example, such information may be sent by electronic mail or provided (possibly to an authenticated client) in a web site. If a serviced component is usable, recovered data may be provided on the serviced component, otherwise, recovered data may be returned using any suitable means or media. Recovered data and/or serviced components may be shipped to a client based on contact information provided, e.g., during an activation of a service as described herein.

Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein. For example, a system may include a non-transitory storage medium such as memory 620, computer-executable instructions such as classifier 625 and a controller such as controller 605. Some embodiments may be provided in a computer program product that may include a non-transitory machine-readable medium, having stored thereon instructions, which may be used to program a computer, or other programmable devices, to perform methods as disclosed above.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. An automated computer-implemented method of generating a contract, the method comprising:
examining storage components installed in a computing device to produce hardware information;
obtaining at least one identification parameter associated with a respective at least one storage component installed in the computing device, the identification parameter uniquely identifying the at least one storage component;
communicating the hardware information and the identification parameter to a server;
storing the hardware information and the identification parameter in a database; and
generating a contract based on the hardware information and based on the identification parameter.

2. The method of claim 1, wherein examining hardware components comprises examining at least one of: a hard disk drive, a solid state drive (SSD), a flash memory and a universal serial bus (USB) storage component.

3. The method of claim 1, wherein examining hardware components comprises examining an arrangement of content stored on a storage component and wherein the hardware information comprises parameters related an arrangement of content on a storage component installed in the computing device.

4. The method of claim 1, wherein examining hardware components comprises obtaining information from a Self-Monitoring, Analysis, and Reporting Technology (SMART) component.

5. The method of claim 1, wherein the contract is one of: a service contract and an insurance policy.

6. The method of claim 1, wherein the contract is related to a recovery of data stored on a storage component installed in the computing device.

7. The method of claim 1, comprising assessing a risk related to a loss of data and wherein the contract is generated based on the risk.

8. The method of claim 1, comprising receiving from a user an indication of an acceptance of a term included in the contract and storing the indication in the database.

9. The method of claim 1, comprising:
receiving request for a service related to a storage component and an identification parameter; and
determining an existence of a service contract based on the received identification parameter; and
if a contract related to the storage component exists, providing a data recovery service related to data stored on the storage component.

10. The method of claim 1, comprising detecting a fault related to a storage component, recording the fault in the hardware information and suggesting an action related to the fault.

11. The method of claim 1, comprising:
encoding at least some of the hardware information and the identification parameter into a unique resource locator (URL);
using the URL to access a server;
analyzing, by the server, the URL to produce an analysis result and validating, based on the analysis result, the hardware information and the identification parameter.

12. The method of claim 1, wherein examining hardware components, producing the hardware information and obtaining the at least one parameter are automatically performed by a module automatically downloaded, over a network, to the computing device.

13. A system including a server and a computing device,
wherein the computing device is to automatically download a module from the server, the module being operative to:
examine storage components installed in the computing device to produce hardware information,
obtain at least one identification parameter associated with a respective at least one storage component installed in the computing device, the identification parameter uniquely identifying the at least one storage component, and
communicate the hardware information and the identification parameter to the server; and
wherein the server is to:
store the hardware information and the identification parameter in a database, and
generate a contract based on the hardware information and based on the identification parameter.

14. The system of claim 13, wherein examining hardware components comprises examining at least one of: a hard disk drive, a solid state drive (SSD), a flash memory and a universal serial bus (USB) storage component.

15. The system of claim 13, wherein examining hardware components comprises examining an arrangement of content stored on a storage component and wherein the hardware information comprises parameters related an arrangement of content on a storage component installed in the computing device.

16. The system of claim 13, wherein examining hardware components comprises obtaining information from a Self-Monitoring, Analysis, and Reporting Technology (SMART) component.

17. The system of claim 13, wherein the contract is related to a recovery of data stored on a storage component installed in the computing device.

18. The system of claim 13, wherein the module is to assess a risk related to a loss of data and wherein the contract is generated based on the risk.

19. The system of claim 13, wherein the server is to:
receive request for a service related to a storage component and an identification parameter; and
determine an existence of a service contract based on the received identification parameter; and
if a contract related to the storage component exists, enable providing a data recovery service related to data stored on the storage component.

20. The system of claim 13, wherein the module is to detect a fault related to a storage component, record the fault in the hardware information and suggest an action related to the fault.
